(19) United States
(12) Patent Application Publication
(10) Pub. No.: US 2020/0068808 A1
(43) Pub. Date: Mar. 5, 2020

(54) LIGHT CONTROL METHOD AND APPARATUS FOR CULTIVATION

(71) Applicant: Mankaew MUANCHART, Muang Surin (TH)

(72) Inventor: Mankaew MUANCHART, Muang Surin (TH)

(21) Appl. No.: 16/469,089

(22) PCT Filed: Nov. 17, 2017
(86) PCT No.: PCT/TH2017/000081

§ 371 Date: Jun. 12, 2019

(30) Foreign Application Priority Data
Dec. 14, 2016 (TH) 1601007443

(51) Int. Cl. A01G 7/04; A01G 9/24; A01G 9/02

(52) U.S. Cl. CPC A01G 7/045; A01G 9/02; A01G 9/249

(57) ABSTRACT

According to aspect of the present invention there is provided the light control method and apparatus for cultivation comprising:

The lighting process that causes plants to tilt out the symmetry axis of the pots. The distance positioning and the appropriate ratio minimize the plant shadow as possible or better. So the plants grow fully and has normal shape like its natural growth without specific plantation in the closed system or in container. But it can be used to all types of houses. Light control can also be used for soil and non-soil plantation.

### TECHNICAL FIELD

The present invention relates to agriculture and engineering, apparatus and method, in particular light control method and apparatus for cultivation.

BACKGROUND

The planting with light control methods continuity develop for solving the problem of plants growth in the unstable environment world or not suitable for specific plant. To plant a good quality and correct the needs of market. So there is the invention of cropping and lighting methods for plants with various methods.

European patent number EP 2893800 A2 announces the hydroponics process and its procedure for controlling the temperature of root plants, synthetic light for growth, control temperature of leaf area and also includes the process of carbon dioxide absorbing in the closed system.

European patent number EP 1771062 B1 announces the cropping processes in urban areas where water control systems are available, lighting control system and the positioning of crop on the vertical grid. As well as control the weather or wind through the structure as design in FIG. 1.

European patent number EP 2493282 B1 announces the method of growing plants in container with vertical plane or different slope. And the amount of nutrient precursors required for the crop to be obtained at least one tree. The lighting of the plants from the front and back. Including the plant nutrient system with slow flowing water.

US patent publication number US2005/003996 A1 discloses how to light the crop with wheel rotary hydroponics or cylindrical in containers with central light source. So the plants receive the light throughly and reduce the shade of the plants, as shown in FIG. 2.

To grow good quality plants, the fully growth plants have a method or process for watering and feeding nutrients to plant. The lighting and the weather-wind control process and the humidity-temperature retention include appropriate spacing for plant growth. And for growing the better plants, we take into account how to control the heat, especially the heat above and under the leaves of the plant to specific plant. The remove or reduce the shade of plants to light all parts of the plant, which is a key factor in grow and control the shape of plants. At the same time, we take into account the space used not only for cropping, but also consider using most cost-effectively the area of house. To reduce production costs such as vertical cropping and nested layer planting, etc.

For reasons of changing environmental and food shortages in many regions of the world, the plant growth system improve continuously, such as improving the durable environment plant, the crop plantation, agricultural equipment, the determination of the appropriate light intensity for planting, the various feeding plant nutrients, planting process in environmentally controlled systems, treatment of diseases of plants, etc., but not focuses on the angle plane cropping. By angle plane cropping, it can enhance the air-based production efficiency in industrial base. That can increase the growth area of the plant without expanding the house area. It helps solve the problem of insufficient crop area and reduce the harvest time without chemicals nutrients. It increases the productivity and also keep product safety and environmental friendly. To remove or reduce the shade of plants reduce the heat temperature of the leaf area of the plant lower than the previous system. And still keep the shape of plants suitable for marketing. In addition to remove or reduce the shade of plants will keep energy consumption for controlling cropping temperature lower.

### SUMMARY OF INVENTION

According to the present invention there is provided the light control method and apparatus for cultivation comprising:

Prepare pots with rooting points of plants that cause the symmetrical axes of the plant to tilt off the symmetry pot and set the light source (6), control the angle plane of plant, and definition of group ration for remove or reduce the plant shadow as possible or better. So the plants grow fully and has normal shape like its natural growth. Furthermore, reducing the heat of the leaves of the plant and harvest corp.

### BRIEF DESCRIPTION OF THE DRAWINGS

An embodiment, incorporating all aspects of the invention, will now be described by way of example only with reference to the accompanying drawing in which

FIG. 1 is a view of European patent number EP 1771062 B1 which reveal a cropping system in the city with water control system, lighting control system and vertical cropping on vertical nest.

FIG. 2 is a view of the US Patent form. US2005/003996 A1 announces the lighting of the wheel hydroponics crop. The light source is provided in the center of the wheel. FIG. 3 is drawing shows the process or the exposure method of a typical plant. FIG. 4 is drawing shows how the plant exposure by using a design device.

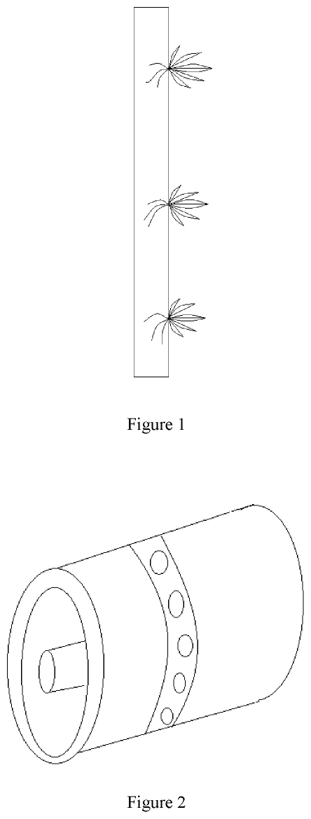

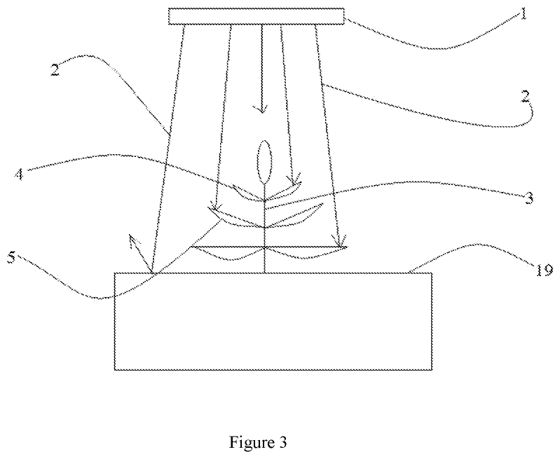

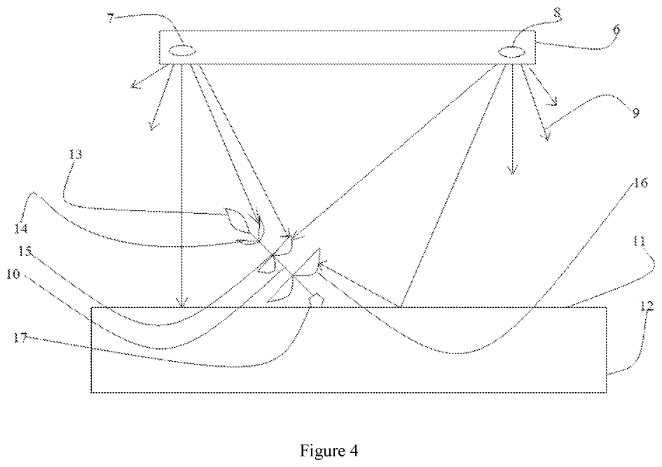

### DETAILED DESCRIPTION

Definition of group ratio and discrepancy which refers to the comparable gauge with same unit and there are discrepancies ratio in between the defined discrepancy. That count as this ratio member and same discrepancies. The member of group ratio and discrepancies can write as follows. Ratio A: B: C discrepancies D where A, B, C, D are positive real numbers, and D is greater than or equal to 0. That is A can be a number from A−D to A+D and B can be a number from B−D to B+D and C can be a number from C−D to C+D.

If any group ratio and discrepancy can be written as a group ratio and a least discrepancy A: B: C discrepancy D which are counted as the same group ratio and discrepancies. The definition of group ratio and discrepancy means that any divisor number are divided both ratios and discrepancies until a prime number is in a particular ratio, the discrepancy can be a fraction.
Example 1 Group Ratio 1: 2: 3 Discrepancy 0.4 There are members as. 0.6: 2: 3, 1: 2.4: 3, 1: 2: 3.3, 1.1: 1.9: 2.8, 1.4: 2.4: 3.4, 0.6: 1.4: 2.6, etc.
Example 2 Ratios of 0.6: 2: 3 are member of group ratios 1: 2: 3 discrepancy 0.4 and also are the member of group ratio 1: 2: 3 discrepancy 0.5, and are same the member of group ratio 2: 2: 2 discrepancy 0.5.
Example 3 Group ratio 12: 4: 8 discrepancy 5 can be written as:
Group ratio 12: 4: 8 discrepancy 5 equivalent to group ratio 5: 6: 2: 4 discrepancy 2.5 and also equivalent to group ratio 3: 1: 2 discrepancy 1.25. As show that all group ratio and discrepancy are the same.

The method or process of general plant exposure is shown in FIG. 3. Place the plant (3) with the light source (1), let the light (2) leaves the light source (1), the light (2) hits the plant (3) to photosynthesis by plants (3) which divided into two parts: Full light leaves (4) and the leaves planted conceal by the top leaf (5). Full light leaves (4) will grow fully. The leaves are broadly broadened by the full exposure of light (2). The leaves planted conceal by the top leaf (5) are partially out of light (2) or have less light intensity (2) because of the shadow of the above plants. So the plant is not fully growth and the quality of the leaf drops. In addition to the light (2) hit the plants, some light fall into the surface (19), which will refract the light (2) and reflect or shine through the surface, such as soil, water, metal, media. That depend on the planting system which determine the surface (19). Such the soil cultivation (19) will be soil where light (2) will be reflected or shed, depending on soil conditions. The surface (19) of rail cultivation will be the material surface where the light (2) is reflected. The surface of floating plants (19) will be water where the light (2) will have both reflection and partial light. According to aspect of the present invention light control method and apparatus for

cultivation is described as the definition of group ratio and discrepancy, that including of,
i. Prepare pots with rooting points of plants that cause the symmetrical axes of the plant to tilt off the symmetry pot. By tilting in the range of 10-89 degrees from the symmetry pot.
ii. Arrange the light source to the symmetry axis of the light source parallel or tilt from the parallel axis not exceed or equal to 50 degrees with any one of the symmetrical pot. The light source uses a type of the light emitting diode with each position of sources spaced out periodically. From studying and testing, It was found that the suitable type of light emitting diode is light emitting diode strip (LED strip).

Plant pot have special characteristics that suitable for the method, comprising:
1. Material of plant pot must be selected to suit the cost, corrosion resistance, light weight. From testing, the suitable materials for making pot are Polyvinyl Chloride, Polyethylene or Polypropylene, 316L Stainless Steel, Stainless steel 304, stainless steel grade 308 or equivalent. The most appropriate material is Polyvinyl chloride.

2. The pot must have color that can reflect the light together and diffused the light thoroughly by choosing the colors of clothing plastics or plastics itself. The require color can be given the density of photosynthetic photon flux density (PPFD) within the cultivation area from 100-1000 micron mol/sqr.m. sec. optimally, the proper fluid of photosynthetic photon flux density (PPFD) is 100-500 micron mol/sqr.m. sec.

3. The preparation of the root point on the plant pot has two characteristics. The first characteristic is for molding the material stainless steel 316L, stainless steel 304, stainless steel 308 or injection molded plastic for Polyvinyl Chloride or Polyethylene or Polypropylene. The second is to cut the wall of the pot into various shapes, by each shape has the shortest suitable core is 30-50 millimeters, then fix all of pot sequentially and cylindrical. The shortest core of the ideal pot is 35-40 millimeters, because they are the ideal diameter size for growing the plant. The fixed cylindrical pot can be call the root point of the plant as soon as it is welded.

How to exposure the light of a plant using a given device that can be shown in FIG. 4. The light source (6) with light point spaced interval periodically is the light spot (7) and the light spot (8) which emit the light (9) all direction. So that the plant (10) grow on a pot with a root point of the plant tilt from the symmetry axis pot (12) grow in direction of the light source (6) and direct towards the light point (7) near the apex of the plant (13) rather than the light spot (8). The full of light exposure leaf (14) at the top and near the apex of the plant (13) can grow fully because any the leaves plant cover by the shadow. The leaves cover by the top leaves (15) near the apex of the plant (13) will receive the light (9) from the light source (6) in two ways: the light spot (7) and the light spot (8). That makes the shadow less intense or none shadow at some leaf. The leaves which covered by the above leaves around the base of the leaf plant (16) are most directly exposed by the light source (6) least intense because of many above leaves. However, it is possible to receive light (9) from the impact of light from the pot surface (11). This reduces the problem of blocking one another from the top source exposure only. Normally, the leaves of this area will grow poorly and some leaf plant will look yellow and fall off eventually become a fully plant growth, not yellow and not fall off.

From testing, it found the suitable the condition of pot surface (11) that was touched surface by hand or look with the eyes to feel uneven and roughly. Textured surface touch by hand or visible is rough, uneven, and rough feel, it gives the most light impact and most reflection.

From the tests and calculations found that, the spacing must be arranged by considering the direction of light when falling on the plant that will offset each other and does not cause shadows or less shadows. The spacing of the light spots (7) and (8) next to each other is in the range of 2-20 cm. The optimal spacing is 2-10 cm. The spacing of the root points of each plant is in the range of 20-60 cm. The optimal spacing is 25-35 cm. So that the plant does not overlap with neighboring plants.

And the distance between the root point of the plant (17) and the light source (6) has an optimal spacing of 15-200 cm. The best optimal spacing is 15-60 cm that can cancel the

shadow lease. And the number of photoperiod that plant receives light during a day increase by 97 percent directly compared to vertical cropping and top light source.

And the ratio between the distance of the light spots in the light source to the distance of the root point of the plant and to the distance between the plant root point and the light source, the ratio and the optimal tolerance is group ratio 1: 6: 7 discrepancy 1.8. The optimal is group ratio 1: 6: 7 discrepancy 0.5.

Removing or reducing the shadow of the plant will give the plant full exposure. The more removing or reducing the shadow impacted on the plant, so the plants grow well and also keeps the plants from deforming as the normally plants should be. That depend on the plants in each species. As in the comparison planting table and lighting with the following apparatus:

| | The root point | The root point | The root point | The root point |
|---|---|---|---|---|
| | of the plant is | of the plant is | of the plant is | of the plant is |
| | set directly | set parallel to | tilted to the | perpendicular to |
| Plant | above the light. | the side light. | lateral line light. | the side light. |
| Chinese kale | normal | Leaf blades | normal | Deformed |
| Cos lettuce | normal | Leaf blades | normal | normal |
| Mizuna | normal | Deformed | normal | Deformed |
| Morning glory | normal | normal | normal | Deformed |
| Celery | normal | Deformed | normal | Deformed |
| Butter head | normal | Leaf blades | normal | normal |

When arrange the cropping apparatus according to the above arrangement of the pots and light sources and increase the winds. That blow through the leafs of the plant for giving more carbon dioxide to plants. And blows out the oxygen from the growth of the plant that reduce the heat of the leaves of the plant. The appropriate air speed is 0.2-5 meters per second and the best optimal air speed is 0.3-3 meters per second. That can be reduced the heat of the leaf area 92 percent compared to the normal plants. And it can also maintain humidity above the leaf at 40 to 80 percent relative to humidity in the system. It depends on the humidity of each plan leaf. From experiment that adjusted the photosynthetic photon flux density (PPFD) at 100 -1000 microns per square meter per second and arrange the pots and light sources. From the above condition, the 45 days of harvested crops can be harvested within 30 days, which can accelerate the harvesting process by approximately 33 percent compared to normal harvesting. The optimal the photosynthetic photon flux density (PPFD) is 150-800 microns per square meter per second.

When testing the light provided in the management of the greenhouse, any one of the spectrum F3, F5, F7, F9 and X5 will effectively control plant growth.

1. Light control method and apparatus for cultivation consist of prepare pots with rooting points of plants that cause the symmetrical axes of the plant to tilt off the symmetry axis pot (12) in the range of 10-89 degrees and arrange the light source (6) to the symmetry axis of the light source parallel or tilt from the parallel axis not exceed or equal to 50 degrees with any one of the symmetrical pot.

2. Light control method and apparatus for cultivation in accordance with claim 1 wherein the light source (6) uses a type of the light emitting diode with each position of sources spaced out periodically.

3. Light control method and apparatus for cultivation in accordance with claim 1 wherein the suitable materials for making pot such that pots with rooting points of plants that cause the symmetrical axes of the plant to tilt off the symmetry axis pot (12) are Polyvinyl Chloride, Polyethylene or Polypropylene, 316L Stainless Steel, Stainless steel 304, stainless steel grade 308 or equivalent.

4. Light control method and apparatus for cultivation in accordance with claim 1 wherein the color of pots with rooting points of plants that cause the symmetrical axes of the plant to tilt off the symmetry axis pot (12) can be given the density of photosynthetic photon flux density (PPFD) within the cultivation area from 100-1000 micron mol/sqr.m. sec.

5. Light control method and apparatus for cultivation in accordance with claim 1, wherein the light source (6) which the spacing of the light spots (7) and (8) next to each other is in the range of 2-20 cm.

6. Light control method and apparatus for cultivation in accordance with claim 1 wherein the spacing of the pots with rooting points of plants that cause the symmetrical axes of the plant to tilt off the symmetry axis pot (12) and the root points of each plant (17) is in the range of 20-60 cm.

7. Light control method and apparatus for cultivation in accordance with claim 1 any one of claim 1 6 wherein the distance between the root point of the plant (17) and the light source (6) has an optimal spacing of 15-200 cm.

8. Light control method and apparatus for cultivation in accordance with claim 1 wherein the ratio between the distance of the light spots (7) and (8) to the distance of the root point of the plant (17) and to the distance between the plant root point (17) and the light source (6), the ratio and the optimal tolerance is group ratio 1: 6: 7 discrepancy 1.8.

9. Light control method and apparatus for cultivation in accordance with claim 1 any one of claim 18 wherein the air speed is in the range of 0.2 - 5 meters per second.

10. Light control method and apparatus for cultivation in accordance with claim 1 wherein the light provided in the management of the greenhouse, any one of the spectrum F3, F5, F7, F9 and X5.

11. Light control method and apparatus for cultivation in accordance with claim 1 wherein the suitable the condition of pot surface (11) that was touched surface by hand or look with the eyes to feel uneven and roughly, textured surface touch by hand or visible is rough, uneven, and rough feel.

12. Light control method and apparatus for cultivation in accordance with claim 1 wherein for some, light control method such that the light source (6) with light point spaced interval periodically is the light spot (7) and the light spot (8) which emit the light (9) all direction. So that the plant (10) grow on a pot with a root point of the plant tilt from the symmetry axis pot (12) grow in direction of the light source (6) and direct towards the light point (7) near the apex of the plant (13) rather than the light spot (8). The full of light exposure leaf (14) at the top and near the apex of the plant (13). The leaves cover by the top leaves (15) near the apex of the plant (13) will receive the light (9) from the light source (6) in two ways: the light spot (7) and the light spot (8). The leaves which covered by the above leaves around the base of the leaf plant (16) are most directly exposed by the light source (6) least intense because of many above leaves. It receive light (9) from the impact of light from the pot surface (11).
